(19) United States
(12) Patent Application Publication
(10) Pub. No.: US 2025/0242851 A1
(43) Pub. Date: Jul. 31, 2025

(54) STEERING WHEEL

(71) Applicant: TAIWAN RACING PRODUCTS CO., LTD., Changhua County (TW)

(72) Inventor: Wen-Yuan WU, Changhua County (TW)

(21) Appl. No.: 18/422,497

(22) Filed: Jan. 25, 2024

(51) Int. Cl. B62D 1/06

(52) U.S. Cl. CPC B62D 1/065

(57) ABSTRACT

A steering wheel is provided, wherein the steering wheel includes: a main frame including a central base and a plurality of spoke arms extending radially outward from the central base; an annular core surrounding the central base and directly connected to distal ends of the plurality of spoke arms; at least one heating element in contact with the annular core; and an outer coat structure encompassing the annular core and the at least one heating element.

### BACKGROUND OF THE INVENTION

### Field of the Invention

The present invention relates to a steering wheel, and particularly to a steering wheel which provides a comprehensive heating effect.

### Description of the Prior Art

Vehicles are a common and important means of transportation, and are also commonly used in the field of vehicle sports and competitions. In order to increase the comfort of vehicle drivers, some vehicles are equipped with heated seats, which can warm the seated occupants especially in cold driving environments. Vehicle control depends on the steering wheel, which allows the driver to control the steering wheel for a long time, so some vehicles are equipped with heated steering wheels, which can warm the driver's hands in cold driving conditions.

However, the annular core of the conventional heated steering wheel is usually covered with a fairly thick cladding (usually plastic material or foam material, etc.), the heating element is disposed around the radial outer surface of the cladding, and an outer layer (single-layer or multi-layer structure) wraps the heating element. Since the heating element is disposed around the radially outer surface of the cladding, the heat energy will be blocked by the cladding and will not be easily transmitted to the radially inner side of the steering wheel, resulting in the inability to warm a portion of the driver's hands located on the radially inner side of the steering wheel.

The present invention is, therefore, arisen to obviate or at least mitigate the above-mentioned disadvantages.

### SUMMARY OF THE INVENTION

The main object of the present invention is to provide a steering wheel, whereby heat energy can be effectively transmitted to the inner and outer sides of the steering wheel in the radial direction and effectively transmitted to the opposing annular sides in the axial direction, which provides a comprehensive heating effect.

To achieve the above and other objects, a steering wheel is provided, wherein the steering wheel includes: a main frame including a central base and a plurality of spoke arms extending radially outward from the central base; an annular core surrounding the central base and directly connected to distal ends of the plurality of spoke arms; at least one heating element in contact with the annular core; and an outer coat structure encompassing the annular core and the at least one heating element.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is a stereogram of a steering wheel of an exemplary embodiment of the present invention; and

FIG. 4 is a partial cross-sectional view of FIG. 3.

### DETAILED DESCRIPTION OF THE PREFERRED EMBODIMENTS

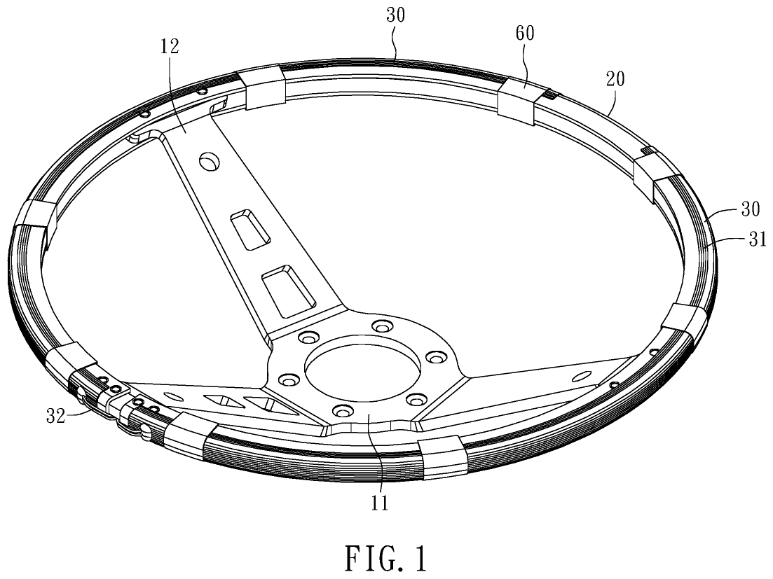

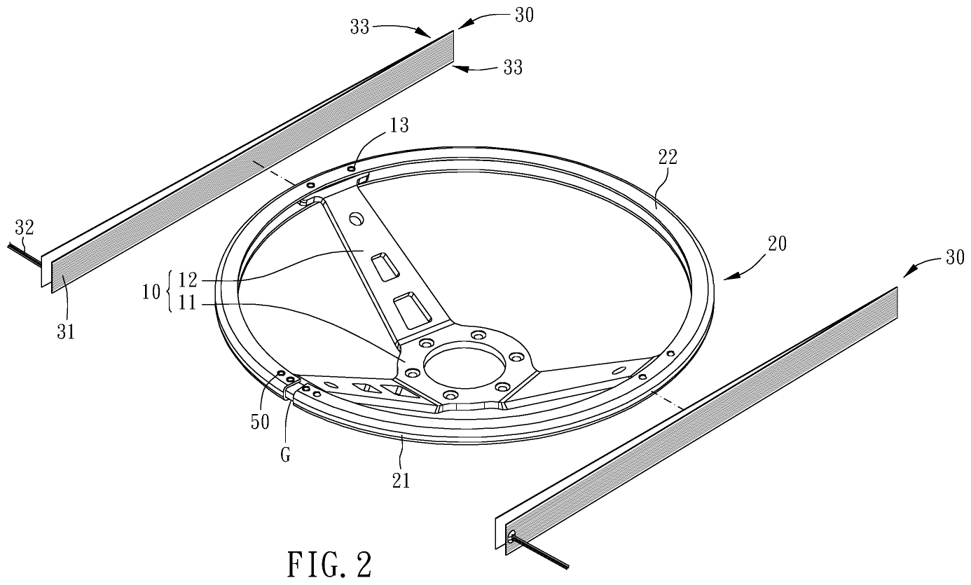

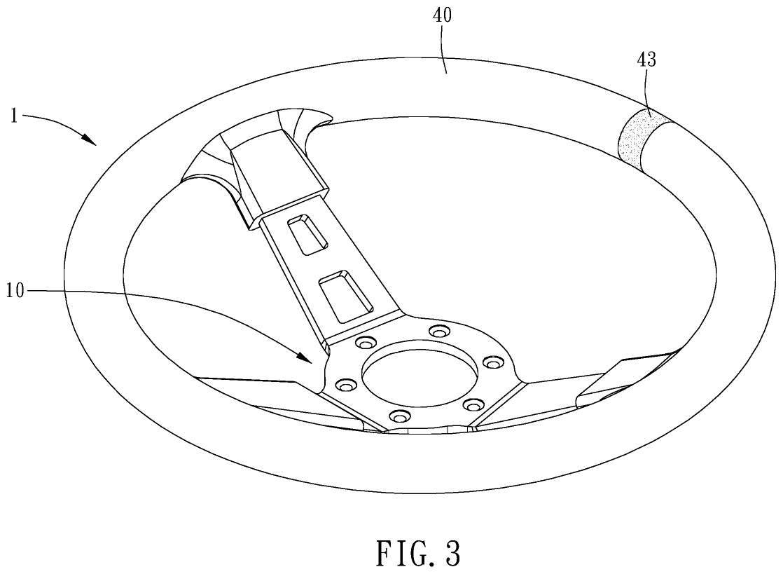

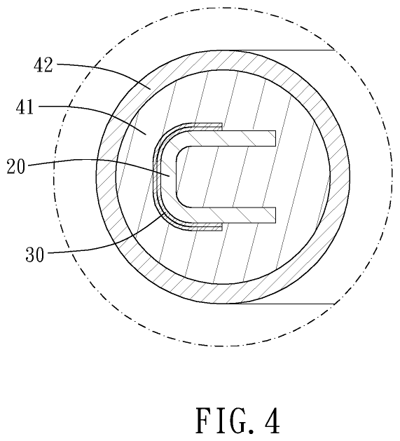

Please refer to FIGS. 1 to 4 for an exemplary embodiment of the present invention. A steering wheel 1 of the present invention includes a main frame 10, an annular core 20, at least one heating element 30 and an outer coat structure 40.

The main frame 10 includes a central base 11 and a plurality of spoke arms 12 extending radially outward from the central base 11, and the central base 11 is configured to be connected to a steering mechanism of a vehicle. The annular core 20 surrounds the central base 11 and is directly connected to distal ends of the plurality of spoke arm 12. The at least one heating element 30 is in contact with the annular core 20. The outer coat structure 40 encompasses the annular core 20 and the at least one heating element 30. Since there is no intermediate layer (such as thermal insulation layer, or other plastic layer or rubber layer) between the annular core 20 and the at least one heating element 30 and the at least one heating element 30 is directly in contact with the annular core 20, heat energy can be effectively transmitted to the inner and outer sides of the steering wheel 1 in the radial direction and effectively transmitted to the opposing annular sides in the axial direction, which provides a comprehensive heating effect.

Preferably, the annular core 20 is made of metal, which can provide good heat conduction effect. The main frame 10 may be made of metal for strong structural strength; however, the main frame 10 and the annular core 20 may be made of other suitable material. Each of the plurality of spoke arms 12 and the annular core 20 are connected to each other at at least one connection point 13, and the at least one heating element 30 covers at least a portion of the at least one connection point 13 so that partial heat can be conducted by the at least one connection point 13 to each of the plurality of spoke arms 12. In this embodiment, the at least one connection point 13 are formed at the point(s) where at least one pin member 50 is connected to each of the plurality of spoke arms 12 and the annular core 20.

Specifically, two distal ends of the annular core 20 correspond to each other and form a gap G therebetween, and one of the plurality of spoke arms 12 is connected to the two distal ends of the annular core 20. The at least one heating element 30 includes a plurality of heating circuits 31 and a plurality of wires 32 (for power supply or/and control) electrically connected to the plurality of heating circuits 31. The plurality of wires 32 extend through the gap G, which can smoothly guide, accommodate, hide and protect the plurality of wires 32, and obtain an integrated structure and flat appearance.

The at least one heating element 30 is secured to the annular core 20. For example, the at least one heating element 30 may be secured to the annular core 20 by at least one method of adhering and wrapping. In this embodiment, the at least one heating element 30 is of a folded configuration so that it is conducive to heating ability, a portion of a heating surface 33 of the at least one heating element 30 faces toward the annular core 20 and another portion of a heating surface 33 of the at least one heating element 30 faces away from the annular core 20, the at least one heating element 30 is adhered to the annular core 20 and is secured to the annular core 20 by a plurality of fastening bands 60 (tape, zip ties or the like), and two halves sections of the at least one heating element 30 are folded and adhered to each other so that the structure is flat and stable. Specifically, the annular core 20 includes an outer circumferential surface 21 and two outer lateral annular surfaces 22, the outer circumferential surface 21 is connected to and between the two outer lateral annular surfaces 22, and the at least one heating element 30 is in contact with the outer circumferential surface 21 and the two outer lateral annular surfaces 22. In this embodiment, the at least one heating element includes two heating element 30; however, the number of the at least one heating element may be different according to various requirements. The two heating elements 30 are respectively disposed on the left and right halves of the annular core 20, allowing for flexible arrangement and easy installation.

The outer coat structure 40 includes a cladding 41 encompassing the annular core 20 and the at least one heating element 30 and an outer layer 42 disposed around the cladding 41, which provides a proper size for holding the annular core 20 and which can protect the at least one heating element 30; the outer coat structure 40 partially covers the plurality of spoke arms 12, which forms a stable structure and positions the outer coat structure 40; the outer coat structure 40 further includes a marking portion 43, and the marking portion 43 and one of the plurality of spoke arms 12 correspond to each other diametrically, which can quickly identify the relative upward direction of the steering wheel 1 for reference during installation or/and operation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A steering wheel including:
a main frame including a central base and a plurality of spoke arms extending radially outward from the central base;
an annular core surrounding the central base and directly connected to distal ends of the plurality of spoke arms;
at least one heating element in contact with the annular core; and
an outer coat structure encompassing the annular core and the at least one heating element.

2. The steering wheel of claim 1, wherein the annular core is made of metal.

3. The steering wheel of claim 1, wherein each of the plurality of spoke arms and the annular core are connected to each other at at least one connection point, and the at least one heating element covers at least a portion of the at least one connection point.

4. The steering wheel of claim 1, wherein two distal ends of the annular core correspond to each other and form a gap therebetween, and one of the plurality of spoke arms is connected to the two distal ends of the annular core.

5. The steering wheel of claim 4, wherein the at least one heating element includes a plurality of heating circuits and a plurality of wires electrically connected to the plurality of heating circuits, and the plurality of wires extend through the gap.

6. The steering wheel of claim 1, wherein the at least one heating element is secured to the annular core.

7. The steering wheel of claim 6, wherein the at least one heating element is secured to the annular core by at least one method of adhering and wrapping.

8. The steering wheel of claim 1, wherein the annular core includes an outer circumferential surface and two outer lateral annular surfaces, the outer circumferential surface is connected to and between the two outer lateral annular surfaces, and the at least one heating element is in contact with the outer circumferential surface and the two outer lateral annular surfaces.

9. The steering wheel of claim 5, wherein the main frame is made of metal; the annular core is made of metal; each of the plurality of spoke arms and the annular core are connected to each other at at least one connection point, and the at least one heating element covers at least a portion of the at least one connection point; the at least one heating element is adhered to the annular core and is secured to the annular core by a plurality of fastening bands; the annular core includes an outer circumferential surface and two outer lateral annular surfaces, the outer circumferential surface is connected to and between the two outer lateral annular surfaces, and the at least one heating element is in contact with the outer circumferential surface and the two outer lateral annular surfaces; the outer coat structure includes a cladding encompassing the annular core and the at least one heating element and an outer layer disposed around the cladding, and the outer coat structure partially covers the plurality of spoke arms; the outer coat structure further includes a marking portion, and the marking portion and one of the plurality of spoke arms correspond to each other diametrically.

10. The steering wheel of claim 1, wherein the at least one heating element is of a folded configuration so that a portion of a heating surface of the at least one heating element faces toward the annular core and another portion of a heating surface of the at least one heating element faces away from the annular core.
